(19) United States
(12) Patent Application Publication
(10) Pub. No.: US 2024/0313381 A1
(43) Pub. Date: Sep. 19, 2024

(54) Transmission line

(71) Applicant: Delft Circuits B.V., Delft (NL)

(72) Inventors: Riemer Sorgedrager, Krimpen aan de Lek (NL); Kiefer James Vermeulen, Delft (NL); Chun Heung Wong, Delft (NL); Wouter Martinus Gerard Bos, Rotterdam (NL); Robertus Franciscus Maria Van den Brink, Den Haag (NL); Sal Jua Bosman, Schijndel (NL)

(73) Assignee: Delft Circuits B.V., Delft (NL)

(21) Appl. No.: 18/572,195

(22) PCT Filed: Jun. 29, 2022
(86) PCT No.: PCT/NL2022/050370

§ 371 Date: Dec. 20, 2023

(30) Foreign Application Priority Data
Jul. 1, 2021 (NL) 2028607

(51) Int. Cl. H01P 3/06; H01R 24/50

(52) U.S. Cl. CPC H01P 3/06; H01R 24/50

(57) ABSTRACT

The invention relates a transmission line for communicating between a first electronic device and a second electronic device comprising a flexible planar transmission line for connecting to the first electronic device, the flexible planar transmission line comprising a first conducting layer, a first dielectric layer, a second dielectric layer, a second conducting layer, and a signal line provided between the first dielectric layer and second dielectric layer, wherein the signal line is provided with a bare portion; an adapter comprising a conducting body provided with a first opening at a first side of the conducting body arranged to receive the flexible planar transmission line; and a first connector provided at a second side of the conducting body, the first connector provided with a contact area at the second side arranged to receive a first connection of a second transmission line for connection to the second electronic device and a pin for receiving a second connection of the second transmission line;

wherein the contact area is electrically connected to the second conducting layer and the adapter further comprises a support arranged to planar deform flexible transmission line to connect the signal line to the pin and the first conducting layer to the contact area.

### FIELD OF THE INVENTION

The invention relates to a transmission line for communicating between a first electronic device and a second electronic device.

### BACKGROUND

The transmission line can be applied for transmitting and receiving signals between an electronic system and a cryogenic circuit. Known transmission lines apply adapters for connecting coaxial transmission lines to planar transmission lines. Such transmission line is known from U.S. Pat. No. 5,986,519.

The cryogenic circuit may comprise, for example, qubit devices, quantum processors, sensing and detector systems, quantum internet apparatus, medical devices, cryptographic devices, classical computing processors, and any other electronic devices. However, there are many other applications using cryogenic electronic circuits, such as multi-pixel superconducting photon detectors used in astronomy and quantum communication applications.

Cryogenic cooling equipment is provided for maintaining the cryogenic electronic circuit at the required operating temperature of near zero Kelvin. This cryogenic cooling equipment is often built up from a stack of separated temperature stages, wherein each lower stage is cooled down to a lower temperature. Due to the fundamentals of thermodynamics, the power required to progressively cool down to lower temperatures increases exponentially. For example, a typical cryogenic cooling equipment consumes 20-30 kW for handling a thermal load of 12-18 μW at 100 mK. The control device for cryogenic systems is typically placed outside the cryogenic equipment to prevent their power dissipation from heating up the cryogenic equipment as a whole and thus the cryogenic circuits as well. Therefore, a communication path is required for exchanging signals between cryogenic circuits at the final stage of the cryogenic equipment, through the top of the cryogenic equipment to an electronic system, for example outside control electronics. Such path is typically constructed from a cascade of semi rigid transmission lines, usually coax cables, to abridge the distance during the cooling down procedure and operation. Cryogenic circuits, such as the qubit devices, require communication with the external control device for controlling the qubits and signaling back an actual state of each qubit to the control device. This requires also high frequency, HF, analogue signals. Typically, this signal can be in the range from low frequencies or DC to ultrahigh frequencies up to 80 GHz.

Recent cryogenic qubit devices have an increasing number of qubits. Each qubit requires individual communication to the control device outside the cryogenic qubit device. This individual communication requires an increasing number of the transmission lines for the qubits. For example, the cryogenic qubit device can comprise 96 qubits and requires at least 288 individual transmission lines that should be guided through subsequent thermal stages to the outside. The transmission lines may each comprise several coax connectors, for example, for bridging the consecutive stages of the cryogenic equipment. So, when the number of transmission lines increases, the total number of connectors in the transmission lines to bridge each stage is also increasing and relatively more space is required to accommodate for this increased number of connectors and may become a limiting condition for a further increase in numbers of qubits. A flat flexible transmission line can be applied to connect the coaxial transmission lines to the qubits of the cryogenic device. An adapter is then required to connect the coax transmission lines with the flat flexible transmission line. However, the connection between the coax transmission line and the flat flexible transmission line in the adapter may negatively influence a transition of an HF signal through the transmission line.

### SUMMARY OF THE INVENTION

It is therefore an object of the invention to mitigate the above indicated problems and to provide a transmission line that enables miniaturization, scalability and to improve the signal transmission.

According to a first aspect of the invention this and other objects are achieved by a transmission line for communicating between a first electronic device and a second electronic device comprising
a flexible planar transmission line arranged to connect the first electronic device, the flexible planar transmission line comprising a first conducting layer, a first dielectric layer, a second dielectric layer, a second conducting layer, and a signal line provided between the first dielectric layer and the second dielectric layer, wherein the signal line is provided with at least a bare portion;
an adapter comprising a conducting body provided with a first opening at a first side of the conducting body arranged to receive the flexible planar transmission line and a first connector provided at a second side of the conducting body, the first connector provided with a contact area at the second side arranged to receive a first connection of a second transmission line for connection to the second electronic device and electrically connected to the second conducting layer, and a pin arranged to receive a second connection of the second transmission line;
wherein the contact area is connected to the second conducting layer;
and wherein the adapter further comprises
a support arranged to planar deform the flexible transmission line to connect the bare portion of the transmission line to the pin and the first conducting layer to the contact area.

In this application planar deforming is defined as deforming the flexible transmission line such that a direction parallel to the width of the flexible transmission line and perpendicular to the signal line is constant along the flexible transmission line in the adapter.

In this arrangement the support is pressing the bare portion of the signal line to the pin to ensure an electrical contact between the pin and the coaxial transmission line at one side and the signal line of the flexible planar transmission line at the other side.

By planar bending, the first conducting layer and the second conducting layer respectively remain adjacent to the signal line up to the contact area. This arrangement provides a reduced connection path, without detour, for electrical currents from both first and second conducting layers to the contact area, and provides a fluent transition of the EM-field from the flexible transmission line to the first connector.

Furthermore, an improved HF signal transmission through this transmission line is ensured into to the GHz ranges.

Furthermore, in this arrangement the pin can be removably connected to the central core of the transmission line.

Another advantage is that this arrangement enables connections between non-superconducting layers and superconducting layers.

In a preferred embodiment according to this disclosure, the transmission line comprises the second transmission line, the second transmission line is provided with a second connector, the second connector comprising the first connection of the transmission line and the second connection of the transmission line and the first connector is detachably connected to the second connector. In this arrangement the flexible planar transmission line, the adapter and the second transmission line are integrated in one device.

In a further embodiment according to this disclosure, the second transmission line is a coaxial transmission line comprising a shielding, a dielectric and a central core, wherein the first connection is to the shielding and the second connection is to the central core and wherein the second connector is a coaxial connector provided with a housing made of metal forming the first connection and a further pin or sleeve forming the second connection. The second connector can be a coaxial connector, for example a male SMA connector or female SMA connector.

In a further embodiment according to this disclosure, the support comprises a first adjustment provided at a third side of the conducting body opposite to the second side arranged to apply a first force in a direction aligned with the longitudinal axis of the pin. By the first adjustment the force can be adjusted manually, for example, by a screw and when a correct adjustment is reached, the first adjustment can be fixed. By this force, a rigid connection is between the signal line and the pin

In a further embodiment the first adjustment comprises a first screw or a spring-loaded device. In this arrangement the first screw is mounted in a hole in the third side and can apply a force between the signal line and the pin when the first screw is tightened. The spring-loaded device can be a so-called “pogo”.

In a further embodiment according to this disclosure the first adjustment comprises an electro-mechanic actuator arranged to apply the first force when a control signal is received. The electro-mechanic actuator can be activated by a control signal. In an embodiment the electro-mechanic actuator is a piezo-electric device. Also, other electro-mechanic actuators can be applied for example an electro-magnetic device. After the transmission line is installed a control signal can be applied to the electro-mechanic actuator and the HF connection can be made.

In a further embodiment according to this disclosure the support comprises a second adjustment provided at a third side of the conducting body opposite to the second side arranged to provide a second force at an end of the transmission line. The second adjustment can be a second screw or spring-loaded device. In this arrangement, when the second screw is tightened, the second screw applies a second force on the second conducting layer to ensure electrical contact with the contact area of at the second side of the adapter. In this arrangement the support planar deforms the flexible transmission line and the signal line is connected to the pin and the first conducting layer and the second conducting layer are connected to the contact area. In this arrangement the HF path between the first conducting layer, the signal and the second conducting layer and the second connector is further reduced.

In a further embodiment according to this disclosure the transmission line is provided with a third dielectric layer at the side of the first conducting layer directed away from the first dielectric layer. This third dielectric layer protects the first conducting layer.

In a different embodiment according to this disclosure the support further comprises a conducting portion between the end of the first conducting layer and the contact area. In this arrangement the HF path between the first conducting layer, the signal line and the second conducting layer and the second connector is further reduced by the conducting portion.

In a further embodiment according to this disclosure the conducting portion comprises a third conducting layer faced to the first conducting layer and the third conducting layer is provided with a fourth dielectric layer at a side faced away from the first conducting layer. In this arrangement a simple end of the flexible transmission line can be used.

In a different embodiment according to this disclosure the adapter comprises a bead between the flexible transmission line and the first connector, wherein the bead is provided with a sheathing, a second dielectric, and the pin, wherein the sheathing is electrically connected to the contact area and the first conducting layer. This arrangement can be used for a hermetic sealing of the adapter. The bead can be, for example, a glass bead.

In a different embodiment according to this disclosure the adapter comprises a printed circuit board, wherein the printed circuit board is provided with a first via and a second via, wherein the contact area is electrically connected to the first conducting layer through the first via, and wherein the second via comprises the pin.

The invention further relates to an electronic device comprising a transmission line according to any of the claims 1-13.

According to a second aspect of the invention this and other objects are achieved by a method of adjusting a transmission line according to any of the claims 1-13 comprising the steps of, in this order:
a) providing an HF signal at one end of the transmission line with a frequency spectrum in the range of DC −80 GHZ;
b) measuring an output HF signal and the one end or another end of the transmission line;
c) adjusting the force through the support based on a characteristic of the output HF signal; and
d) fixate the first support in a fixed position.

In an embodiment the first adjustment can be fixed by a super glue or epoxy or welding. The characteristic of the HF output signal can be, for example, the transmission or attenuation of the transmission line in a frequency range for example from 0 to 15 GHz.

These and other features and effects of the present invention will be explained in more detail below with reference to drawings in which preferred and illustrative embodiments of the invention are shown. The person skilled in the art will realize that other alternatives and equivalent embodiments of the invention can be conceived and reduced to practice without departing from the scope of the present invention.

### BRIEF DESCRIPTION OF THE DRAWINGS

FIG. 1 shows an intersection of a transmission line provided with a support according to an embodiment according to this disclosure;

FIG. 2A shows an intersection of a transmission line provided with a support according to an embodiment according to this disclosure;

FIG. 2B shows an intersection of a transmission line provided with a support according to an embodiment according to this disclosure;

FIG. 3 shows an intersection of a planar transmission line according to an embodiment according to this disclosure;

FIG. 4 shows an intersection of an embodiment of the transmission line according to an embodiment of this disclosure;

FIG. 5 shows an intersection of a transmission line according to an embodiment of this disclosure;

FIG. 6 shows an intersection of a transmission line according to an embodiment of this disclosure;

FIG. 7 shows an intersection of a transmission line according to an embodiment of this disclosure;

FIG. 8 shows an intersection of a transmission line according to an embodiment of this disclosure.

FIG. 9 shows a test arrangement comprising a transmission line according to an embodiment of this disclosure; and

FIG. 10 shows an electronic device, a cryogenic circuit, and a transmission line according to an embodiment of this disclosure.

### DETAILED DESCRIPTION OF EMBODIMENTS

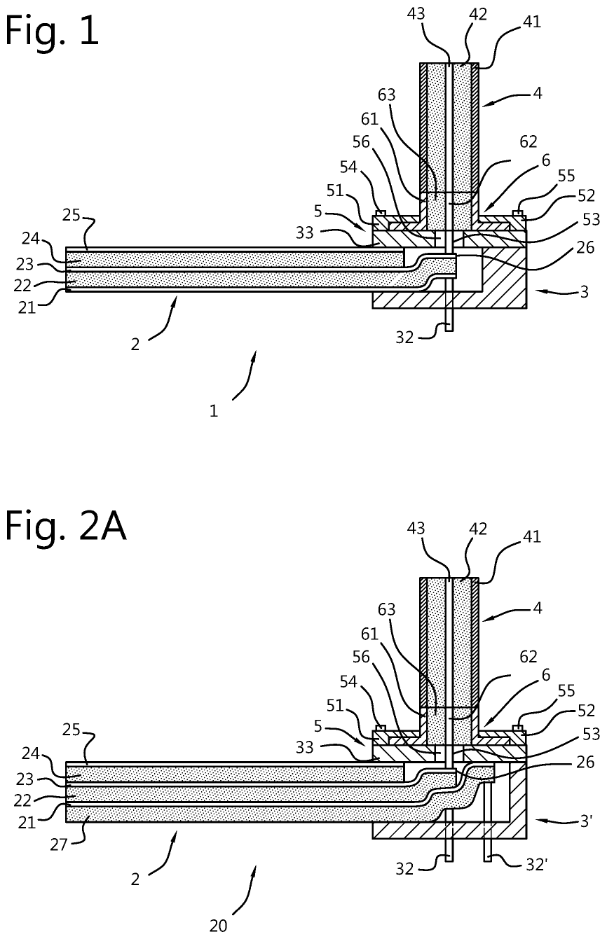

In the figures like numerals refer to like parts. The invention is explained with reference to FIGS. 1 to 10. The transmission line can be used for communication between a first electronic device and a second electronic device. The first electronic device can be, for example, an electronic circuit at room temperature and the second electronic device can be, for example, a cryogenic electronic circuit at a temperature of about 10 mK. The cryogenic circuits can be, for example, a qubit device. The planar transmission line can also be applied between two consecutive stages at different temperatures inside a cryogenic cooling device.

FIG. 1 shows diagrammatically a cross-section of a transmission line 1 according to an embodiment of this disclosure. The transmission line 1 comprises a flexible planar transmission line 2, an adapter 3 and further transmission line 4.

The flexible planar transmission line 2 comprises a stack of a first conductive layer 21, a first dielectric layer 22, a second dielectric layer 24, and a second conductive layer 25. A signal line 23 is provided on the first dielectric layer 22 at a side directed away from the first conducting layer 21 between the first and second dielectric layers. The signal line 23 is provided with a bare portion 26 of the flexible planar transmission line 2 inserted in the adapter 3. The flexible planar transmission line 2 can have rectangular geometry with a length of, for example, 100 mm or 200 mm and a width of e.g., 4 mm and a thickness of e.g., 0.3 mm. The first and second dielectric layers can be for example polyimide or Polytetrafluoroethylene, PTFE, Ethylene tetrafluoride ethylene, ETFE. In embodiments quartz, silicon and printed circuit board materials can be applied. The flexible planar transmission line 2 can be manufactured by providing a polyimide sheet forming the first dielectric layer 22 with the first conductive layer 21. For example, the first conductive layer 21 can be provided by sputtering, electroplating or another thin or thick film process as is well known by the person skilled in the art. The thickness of the polyimide sheet is in the range, for example, from 0.012 mm to 0.4 mm. In an embodiment the conductive layer comprises silver Ag. Also, gold Au and copper Cu can be applied. In an embodiment the conductive layers 21,25 comprise superconductors, for example one of Aluminum, Al, Niobium Nb, NiobiumTitanium, NbTi, NiobiumTitaniumnitride, NbTiN, and Indium, In.

In an embodiment the conductive layers 21,25 comprise a resistive film, for example, one of Nichrome, NiCr, Carbon C, platinum Pt and IndiumTinOxide, ITO. The thickness of the first and second conductive layers 21, 25 is, for example, 2 μm. The second dielectric layer 24 can also be formed by a polyimide sheet. The first dielectric layer can be provided with the first signal line 23. In an embodiment the side of the first dielectric layer 22 facing away from the first conductive layer 21 can be provided with the first signal line 23. The signal line 23 can be located at the center of the first dielectric layer. The signal line 23 comprises a conductive material for signal transmission. In an embodiment the signal line 23 can be made of the same conductive material as is used in the first conductive layer 21. The signal line 23 can have a width of, for example, 0.15 mm and a thickness of, for example, 0.002 mm. The thickness of the polyimide sheet can be, for example. 0.1 mm. Then the second dielectric layer 24 and the second conducting layer 25 are provided. The flexible planar transmission line 2 can be provided with additional layers of polyimide to obtain a wished thickness. The stack of layers can be formed by gluing, laminating, welding, cold welding, ultrasonic soldering, sealing, blade coating, spin coating or dielectric resin. The total thickness of the flexible planar transmission lines may be, for example, 0.3 mm.

In embodiments the thicknesses of the first and second conducting layers 21,25 of the flexible planar transmission line can have a value selected from the range between 0.1 and 5 μm. For example, this value can be 2 μm. In an embodiment an end of the conductive layer at a cold side of the flexible planar transmission line may comprise a superconductor, for example one of Aluminum, Al, Niobium Nb, NiobiumTitanium, NbTi, NiobiumTitaniumnitride, NbTiN, and Indium, In. and at that end the thickness may be reduced to 10 nm and at the other end of flexible planar transmission line the conductive layer may comprise silver with a thickness of up to 35 μm, typically in the range of 10-100 nm.

In an embodiment the adapter 3 is formed by a conducting body. The conducting body can be a rectangular block or box. The block can be made of metal, for example, a copper plate or a copper plate provided with gold plating on the inner side and the outside. The thickness of the walls of the conducting block can be for example 3 mm. The conducting block is provided with a first opening 33 in a first side of the block and a first connector 5 in a second side of the conducting block, adjacent to the first side, wherein the first opening receives the flexible flat transmission line 2.

The first connector 5 is provided with a contact area, a first dielectric 56 in the second side and a pin 53 centrally located in the first dielectric. The contact area comprises a part of the second side of the conducting block and is connected to the first conducting layer 21, the second conducting layer 25 of the flexible planar transmission line 2 and a first connection of the second transmission line 4.

In an embodiment the second transmission line 4 is a coaxial transmission line, wherein the coaxial transmission line comprises a shielding 41, a first dielectric 42 and a central core 43. Furthermore, the transmission line 4 is provided with a second connector 6. The second connector 6 fits with the first connector 5, wherein the second connector comprises the first connection and the second connection of the second transmission line 4. In this arrangement the first connector 5 is detachably connected to the second connector 6.

Furthermore, the second connector 6 is a coaxial connector provided with a housing 61, a second dielectric 63 and a further pin 62, wherein the housing 61 is connected to the shielding 41 and the further pin or sleeve is connected to the central core 43. The housing can be made out of demagnetized stainless steel, the second dielectric can be a synthetic material, for example PTFE, and the central core can be copper. In this embodiment the first connection is a part of the housing 61. The pin 53 is detachably connected to the second connection of the second transmission line 4, wherein the second connection comprises the further pin 62.

In an embodiment the second dielectric layer 24 and the second conducting layer 25 can be left out of the flexible planar transmission. In that embodiment, the first opening 33 of the adapter is provided with a dielectric layer for example polyimide, PTFE or ETFE, to insulate the first opening from the signal line 23. Furthermore, in this embodiment the first contact area is connected to the first conducting layer 21 only.

In an embodiment the signal line 23 can be provided at a part of the same side of the dielectric layer where the first metallic layer is provided and separated from the first conducting layer by a spacing.

Furthermore, the adapter is provided with a support. In this embodiment the support comprises a first adjustment. The first adjustment comprises a first screw 32 wherein the force is set-up by tightening the first screw 32. In an embodiment the first adjustment comprises an electro-mechanic actuator wherein a force is actively applied by the electro-mechanic actuator, for example a piezo-electro device 91 or an electro-magnetic device. An embodiment wherein the electro-mechanic actuator is a piezo-electric device is described with reference to the description of FIG. 8.

Furthermore, in the adapter 3 a first screw hole is provided inside a third side of the conducting block opposite to the second side and in line with a longitudinal axis of the pin 53 to receive the first screw 32. The first screw 32 can have a diameter of 2 mm diameter and a length of 10 mm. When the first screw is tightened a force is applied on the bare portion 26 at the end of the signal line 23 of the flexible planar transmission line 3 via the first metallic layer 21 and the first dielectric layer 22 in a direction aligned with the longitudinal axis of the pin 53. This force planar deforms the flexible planar transmission line 3 and connects the signal line 23 to the pin 53. and the first conducting layer 21 to the contact area. This force ensures a good contact quality between the signal line 23 and the pin 53 for transmission of HF signals in the range between 0 and 80 GHz. After testing the first screw 32 can be fixed for example with a super glue or epoxy.

Furthermore, when the first screw is rotated for tightening, the first dielectric layer 22 prevents damage of signal line 23 due to the rotating end of the first screw 32. Furthermore, the pin 53 of the first connector 5 electrically connects to the further pin 62 of the second connector 6 to the bare portion 26 at the end of signal line 23 of the flexible planar transmission line 2. The length of the pin 53 can be in the range between 1.5 and 5 mm. The diameter of the pin can be about 1 mm. The end of the pin can be tapered. The pin can be made of copper or brass. This embodiment provides a smooth transition in geometric dimensions of the cross-sections between the central core 43 and the signal line 23 of the flexible planar transmission line and the coaxial transmission line respectively resulting in an improved transition of the HF signals. Furthermore, this arrangement provides a detachable connection between the pin 53 of the first connector 5 and the further pin 62 of the second connector 6.

In this embodiment the housing 61 is provided with a flange and the first connector is provided with two clips 51,52 and screw holes. The screws 54,55 fasten the clips 51,52 such that the clips hold the flange of the housing 61 of the second connector 6. Furthermore, the first conducting layer 21 and the second conducting layer 22 are electrically connected to the shielding 41 of the coaxial transmission line 2 via the contact area of the first connector 5 and the housing 61. In this embodiment the contact area is formed by a part of the clips 51,52 and a part of the conducting block.

Furthermore, in an embodiment the first adjustment can be a spring-loaded device, for example, a so-called Pogo. An advantage of the Pogo is that due to the resilience in the contacts remain reliable at lower or even cryogenic temperatures In an embodiment the first connector 5 is a male SMA connector and the second connector 6 is a female SMA connector.

Furthermore, in embodiments the flexible planar transmission line 2 can be provided with multiple, for example 6, signal lines 23 and the adapter 3 can be provided with six connectors 5 to receive second connectors of six coaxial transmission lines respectively and the adapter is provided with six pins 53 to electrically connect the central core 43 of each coaxial transmission line 4 to the bare portion of each of the signal lines 23 respectively through the further pins 62. Furthermore, the adapter comprises then six first screws 32 to apply a force on the bare portion of the flexible transmission lines 23 respectively in a direction aligned with a longitudinal axis of the respective pins 53.

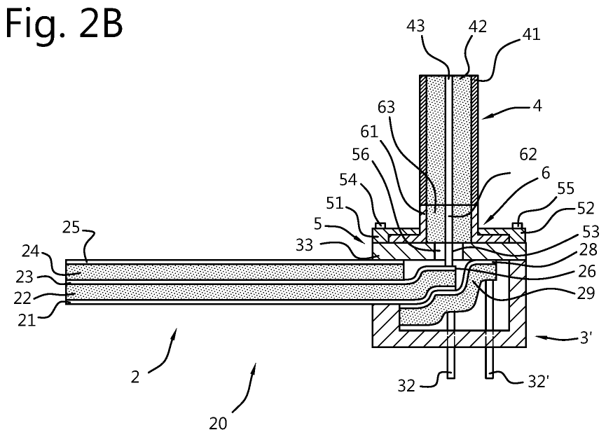

FIG. 2A shows diagrammatically a cross-section of a transmission line 20 with a support according to an embodiment of this disclosure. The transmission line 20 is almost like that as shown in FIG. 1. In this embodiment the flexible planar transmission line 2 is provided with a third dielectric layer 27 at the side of the first conducting layer 21 opposite the first dielectric layer 22. The third dielectric layer 27 can be provided on the flexible planar transmission line 2 in the same way as the first and second dielectric layers 22,24. The first conducting layer 21 and the third dielectric layer 27 are extended in the length direction of the flexible planar transmission over the end of the signal line 23. Furthermore, the flexible transmission line is provided with a bare portion at an end of the first conducting layer 21 facing the second side of the conducting block

Furthermore, the support comprises the first adjustment, for example, the first screw, 32 and a second adjustment, for example, a second screw 32′. Furthermore, a second screw hole is provided in the third side besides the first screw hole such that, when the second screw 32′is tightened, a force is provided at the end of the first conducting layer 21 through the third dielectric layer 27 parallel to the direction of the longitudinal axis of the pin 53 and the end of the first conducting layer 21 is electrically connected to the contact area at the second side of the conducting block 3′. In this arrangement the support planar deforms the flexible transmission line 2 to connect the signal line 32 to the pin 53 and first conducting layer 21 to the contact area respectively. In this arrangement the ends of first conducting layer 21 and the second conducting layer 25 respectively are adjacent to the signal line 23 at the contact area at the second side and a fluent transition of the EM-field from the flexible transmission line to the first connector is provided.

Also, in this embodiment the adapter 3′ is provided with the first connector 5 to detachably connect the second connector 6 at the end of the coaxial transmission line 4. When the first connector 5 is connected to the second connector 6, the two clips 51,52 and the conducting block 3′ are electrically connected to the housing 61 of the second connector 6 to the first metallic layer 21 and the second metallic layer 25 respectively via the contact area of the first connector. The contact area is formed by a part of the clips 51,52 and the second side of the conducting block 3′. The pin 53 of the first connector is electrically connected to the further pin 62 of the second connector and the central core 43 of the coaxial transmission line 4. In this arrangement the HF signal path in the adapter 3′ is shortened compared to the HF path through the adapter in the embodiment of FIG. 1.

Furthermore, in this embodiment, when the second screw 32′ is rotated for tightening, the first conducting layer 21 cannot be damaged by second screw 32′ because the second screw is touching the third dielectric layer 27 that protects the first conducting layer 21.

In an embodiment the second adjustment can be a spring-loaded device. In an embodiment the first and second connector can be coaxial connectors, for example SMA connectors.

In embodiments the third dielectric layer 27 can be dispensed and the second screw can be directly arranged to the first conducting layer 21.

FIG. 2B shows diagrammatically a cross-section of a transmission line 20 with a support according to an embodiment of this disclosure. The transmission line 20 is almost like that as shown in FIG. 1. In this embodiment the support comprises the first adjustment, i.e. the first screw 32, the second adjustment, i.e. the second screw 32′ and a conducting portion or slab. The conducting portion comprises a third conducting layer 28 faced to the first conducting layer 21 and a fourth dielectric layer 29 at a side of the third conducting layer 28 faced away from the first conducting layer 21. The third conducting layer 28 connects the first conducting layer 21 to the contact area. The first screw 31 provides a force in the direction of the longitudinal axis of the pin 53 and connects the signal line 23 to the pin 51 and the first conducting layer 21 to the third conducting layer 28. The second screw 32′ provides a force parallel to the direction of the longitudinal axis of the pin 53 on the fourth dielectric layer 29 and connects the third conducting layer 28 to the contact area. In this arrangement the support planar deforms the flexible transmission line 2 to connect the signal line 32 to the pin 53 and the first conducting layer 21 to the contact area respectively via the third conducting layer 28 and the first conducting layer 21, the second conducting layer 21 and the third conducting layer 28 respectively are adjacent to the signal line 23 and a fluent transition of the EM-field from the flexible transmission line to the first connector is provided.

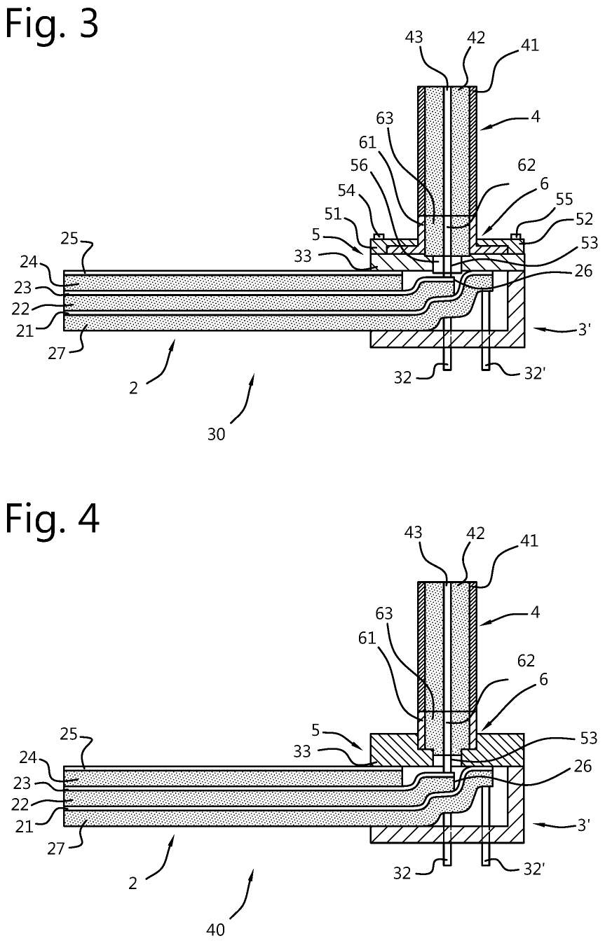

FIG. 3 shows diagrammatically a cross-section of a transmission line 30 according to an embodiment of this disclosure. In this embodiment the transmission line 30 is almost like the transmission line 20 of the embodiment shown in FIG. 2A. Also, in this embodiment the first screw 32 provides a force on the end of the flexible planar transmission line 2 in a direction aligned with a longitudinal axis of the pin 53. The force ensures the HF connection between signal line 23 and the pin 53. A difference is that, in this embodiment the second dielectric 63 extends inside the adapter 3′ such that the end of the second dielectric 63 is between the outer side of the second connector 6 and the end of the further pin 62.

In this arrangement the support planar deforms the flexible transmission line 2 to connect the signal line 32 to the pin 53 and first conducting layer 21 to the contact area respectively. In this arrangement the ends of first conducting layer 21 and the second conducting layer 21 respectively are adjacent to the signal line 23 at the contact area at the second side and the HF and a fluent transition of the EM-field from the flexible transmission line to the first connector is provided.

FIG. 4 shows diagrammatically a cross-section of a transmission line 40 according to an embodiment of this disclosure. In this embodiment the transmission line 40 is almost like the transmission line 20 of the embodiment shown in FIG. 2A. In this embodiment, the housing 61 of the second connector 6 is provided with a screw thread on the outer periphery and the first connector 5 is provided with a screw hole with a screw thread on the inner periphery to receive the screw thread of the second connector 6. This arrangement provides a threaded coupling between the first connector 5 and the housing 61. In this embodiment the contact area comprises the threaded coupling.

Also, in this embodiment the first adjustment in adapter 3′ comprises the first screw 32. The first screw 32 applies a force on the end of the flexible planar transmission line 2 in a direction aligned with a longitudinal axis of the pin 53. The force ensures the HF connection between signal line 23 and the pin 53. Furthermore, the second adjustment comprises the second screw 32′. The second screw provides a force at the end of the third dielectric layer 27 parallel to the direction of the longitudinal axis of the pin 53 to electrically connect the first conducting layer 21 to the contact area of the block 3′ and the housing 61.

In this arrangement the support planar deforms the flexible transmission line 2 to connect the signal line 23 to the pin 53 and first conducting layer 21 to the contact area respectively. In this arrangement the ends of first conducting layer 21 and the second conducting layer 21 respectively are adjacent to the signal line 23 at the contact area at the second side and the HF and a fluent transition of the EM-field from the flexible transmission line to the first connector is provided.

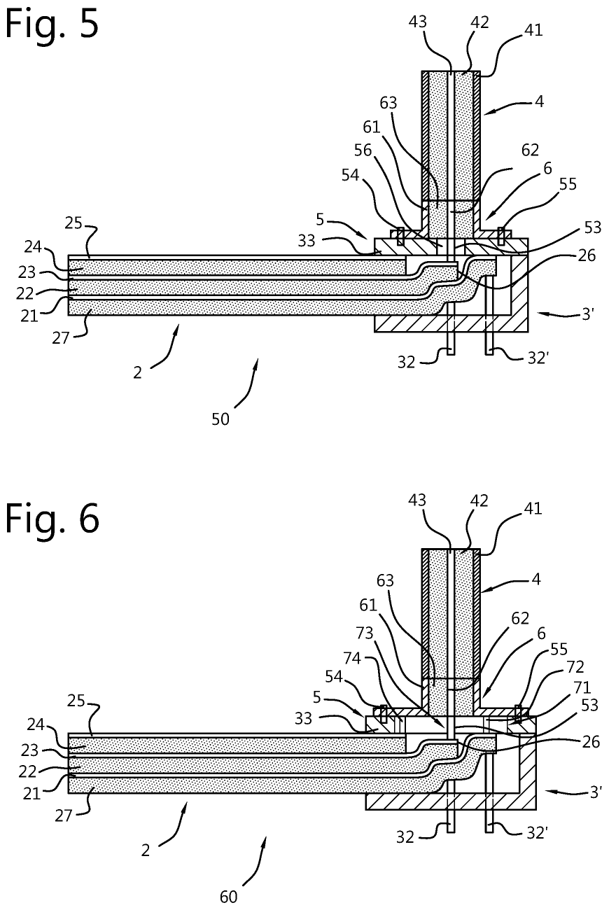

FIG. 5 shows diagrammatically a cross-section of transmission line 50 according to an embodiment of this disclosure. In this embodiment the transmission line 50 is almost like the transmission line 20 of the embodiment shown in FIG. 2A. A difference is that, in the embodiment shown in FIG. 5 the housing 61 of the second connector 6 is provided with a flange provided with two holes and the adapter 3 is provided with screw holes with a screw thread on the inner periphery and screws 54,55 to connect the flange to the adapter 3′ through a threaded coupling. In this embodiment the contact area is formed by an area between the conducting block of the adapter 3′ and the flange. Also, in this embodiment the first adjustment comprises the first screw 32 to apply a force on the end of the flexible planar transmission line 2 in a direction aligned with a longitudinal axis of the pin 3 through the third dielectric layer 27, the first metallic layer 21 and the first dielectric layer 22. This force ensures a good connection between signal line 23 and the pin 53 and a stable transition of HF signals. Furthermore, the second adjustment comprises the second screw 32′, when the second screw is tightened, the second screw provides a force at the end of the flexible planar transmission line parallel to the direction of the longitudinal axis of the pin 53 through the third dielectric layer and the first metallic layer to electrically connect the first conducting layer 21 to the contact area of the conducting block 3′ and the housing 61. In this arrangement the support planar deforms the flexible transmission line 2 to connect the signal line 23 to the pin 53 and first conducting layer 21 to the contact area respectively. In this arrangement the ends of first conducting layer 21 and the second conducting layer 21 respectively are adjacent to the signal line 23 at the contact area at the second side and the HF and a fluent transition of the EM-field from the flexible transmission line to the first connector is provided.

FIG. 6 shows diagrammatically a cross-section of a transmission line 60 according to an embodiment of this disclosure. In this embodiment the transmission line 60 is almost like the transmission line 20 of the embodiment shown in FIG. 2A. A difference is that, in this embodiment, the housing 61 of the second connector 6 is provided with a flange provided with two holes and the adapter 3 is provided with screw holes with a screw thread on the inner periphery and screws 54,55 to connect the flange to the adapter 3′ through a threaded coupling. Furthermore, in this embodiment the adapter 3 comprises a printed circuit board, PCB, 71 provided with three through holes provided with a first via 72, a second via 73 and a third via 74. The first via 72 and the third via 74 are connected to the housing 61 of the second connector 6 and to the first conducting layer 21 and the second conducting layer 25 of the flexible planar transmission line 2 respectively via the contact area. The contact area comprises a part of the conducting block 3 and the flange. The second via 73 comprises the pin 53 that is connected to the further pin 62 of the second connector 6 and the signal line 23. Also, in this embodiment the first adjustment comprises the first screw 32 to apply a force at the end of the flexible planar transmission line 2 in a direction aligned with a longitudinal axis of the pin 53 through the third dielectric layer 27, the first metallic layer 21 and the first dielectric layer 22.

Furthermore, the support comprising a second adjustment. The second adjustment comprises the second screw 32′. The second screw when tightened, provides a g force at the end of the third dielectric layer 27 to electrically connect the first conducting layer 21 to the housing 61 through the conducting block 3′. The force ensures a good connection between signal line 23 and the pin 53. In this arrangement the support planar deforms the flexible transmission line 2 to connect the signal line 23 to the pin 53 and first conducting layer 21 to the contact area respectively. In this arrangement the ends of first conducting layer 21 and the second conducting layer 21 respectively are adjacent to the signal line 23 at the contact area at the second side and the HF and a fluent transition of the EM-field from the flexible transmission line to the first connector is provided.

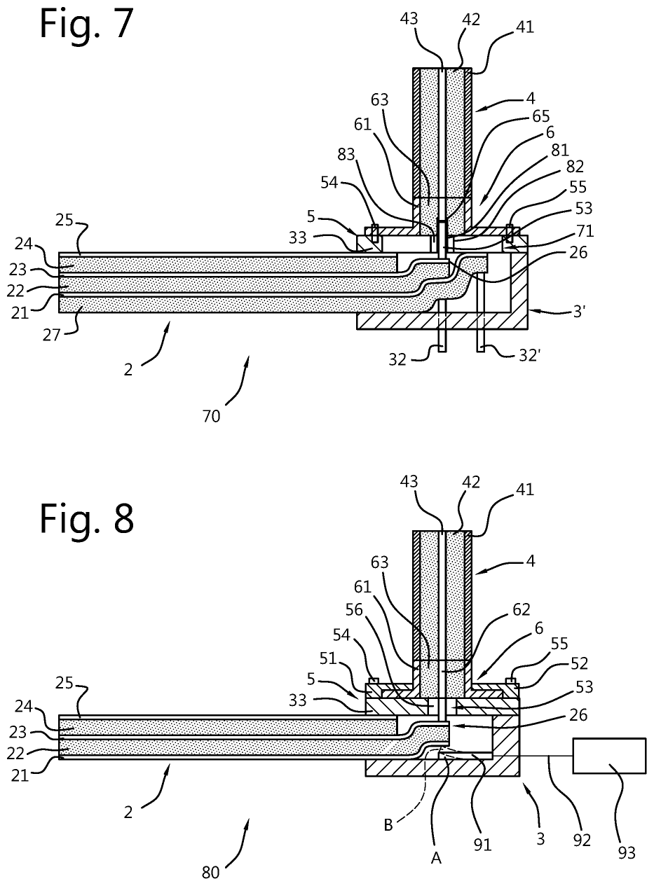

FIG. 7 shows diagrammatically a cross-section of a transmission line 70 according to an embodiment of this disclosure. In this embodiment the transmission line 30 is almost like the transmission line 60 of the embodiment shown in FIG. 6. In this embodiment the second connector 6 comprises the housing 61, the second dielectric 63 and a conducting sleeve 65. In this embodiment the second connector 6 can be a SMA connector of a female type.

Furthermore, in this embodiment the adapter 3′ comprises a bead 81, for example a glass bead, wherein the glass bead comprising a sheathing 82, a third dielectric 83 and the pin 53. The sheathing 82, can be made of copper. The third dielectric can be glass. The length of the pin 53 is sufficient to engage with the conducing sleeve 65. In this embodiment the pin 53 is electrically connected to the conducting sleeve 65 and the signal line 23. The first conducting layer 21 and the second conducting layers 21,25 are electrically connected to the housing 61 through the contact area, wherein the contact area comprises a part of the housing 61 and an area of the adapter between the adapter and the housing 61. Also, in this embodiment the support comprises the first adjustment. The first adjustment comprises the first screw 32. The first screw applies a force on the end of the flexible planar transmission line 2 in a direction aligned with a longitudinal axis of the pin 53 through the third dielectric layer 27, the first metallic layer 21 and the first dielectric layer 22. When the first screw 32 is tightened this force ensures the HF connection between signal line 23 and the pin 53. Furthermore, the support comprises the second adjustment. The second adjustment comprises the second screw 32′. The second screw 32′, when tightened provides a force at the end of the third dielectric layer 27 in a direction parallel the longitudinal axis of the pin 53 and electrically connects the first conducting layer 21 to the contact area of the conducting block 3′. In this arrangement the support planar deforms the flexible transmission line 2 to connect the signal line 23 to the pin 53 and first conducting layer 21 to the contact area respectively. In this arrangement the ends of first conducting layer 21 and the second conducting layer 21 respectively are adjacent to the signal line 23 at the contact area at the second side and the HF and a fluent transition of the EM-field from the flexible transmission line to the first connector is provided.

FIG. 8 shows diagrammatically a cross-section of a transmission line 80 according to an embodiment of this disclosure. In this embodiment the transmission line 80 is almost like the transmission line 1 of the embodiment shown in FIG. 1. The difference is that the first adjustment of the support comprises a well-known piezo-electric actuator 91 and a control line 92 to receive a control signal to deflect the piezo-electro actuator from a first state A, wherein no force is applied, to a state B, wherein the first force is applied, and the force is aligned with a longitudinal axis of the pin 53. The piezo-electric actuator can be a strip bending actuator wherein one or both ends are fixed. If one end of the piezo-actuator is fixed the other end bends, if both ends of the piezo-actuator are fixed, the center deflects to generate displacement. The control line 92 can be connected with a controller 93. The controller 93 is arranged to active the piezo-electric actuator to provide the first force on the bare portion 26 at the end of the signal line 23 of the flexible planar transmission line 3 via the first metallic layer 21 and the first dielectric layer 22 in a direction aligned with the longitudinal axis of the pin 53. This force ensures a good contact quality between the signal line 23 and the pin 53 for the transmission of HF signals in the range between 0 and 80 GHz.

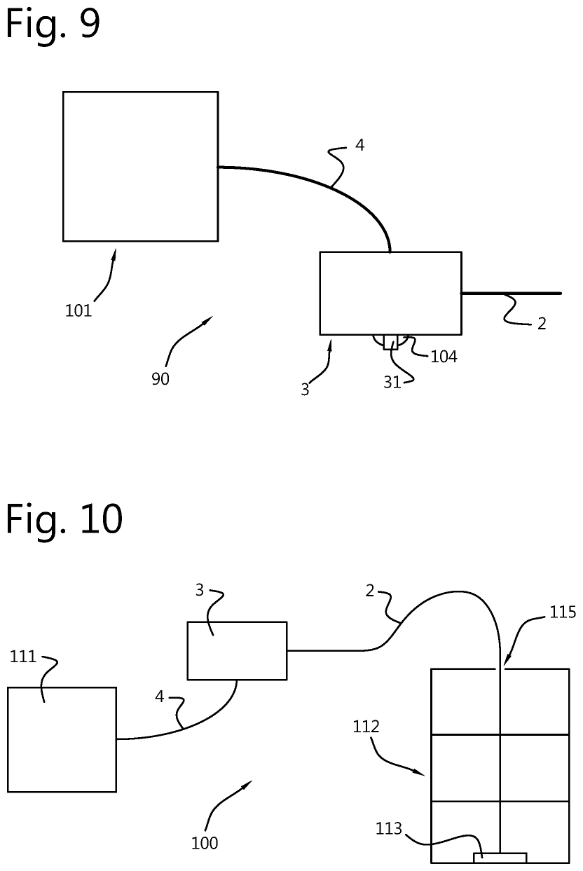

FIG. 9 shows a test arrangement 90 comprising a vector network analyzer, VNA, 101 and a transmission line that can be used for testing the HF transmission. The transmission line comprises the flexible planar transmission line 2, the adapter 3 and the second transmission line 4 according to an embodiment of this disclosure.

The VNA 101 can be a P937xA as can be obtained from Keysight, USA. The VNA is connected to a personal computer. Furthermore, the inputs and outputs of VNA 101 are connected to an input of the coaxial transmission line 4 and the output of the flexible planar transmission line 2 respectively. Alternatively, the inputs and outputs of the VNA can be connected to only one side of the transmission line.

In operation, the VNA generates the HF signal. The HF signal contains frequencies in the range between 0 and 80 GHz. The adjustment of the transmission line can be then performed by the following steps, in this order,
providing the HF signal to an end of the axial transmission line 4;
measuring an output HF signal at the one end or another end of the transmission line;
adjusting the force through the first adjustment, for example, by tightening of the screw 31 until the output signal is measured by the receiver 103; determining a characteristic of the output HF signal, for example a transmission or attenuation of the transmission line; and, in a final step, when the characteristic has a predetermined value fixate the screw 31 in a fixed position to the adapter 3 using a glue 104, for example, a super glue or epoxy. The predetermined value for the attenuation can be for example −15 db.

FIG. 10 shows an electronic system 100 comprising a first electronic device 111, a second electronic device 113 and a transmission line according to an embodiment of this disclosure. In this arrangement the first electronic device 111 is an electronic control circuit. The second electronic device 113 is a cryogenic circuit provided in a cryogenic cooling device 112 or fridge. The transmission line provides communication between the electronic control circuit and the cryogenic circuit. The transmission line can be according to one of the embodiments of FIGS. 1-8. The flexible planar transmission line 2 enters the fridge through a dedicated port 115. The flexible planar transmission line 2 can be connected to the coaxial transmission line 4 through the adapter 3.

Although illustrative embodiments of the present invention have been described with reference to the accompanying drawings, it is to be understood that the invention is not limited to these embodiments. Various changes or modifications may be affected by one skilled in the art without departing from the scope or the spirit of the invention as defined in the claims. Accordingly, reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, it is noted that the particular features, structures, or characteristics may be combined in any suitable manner in one or more embodiments.

1. Transmission line for communicating between a first electronic device and a second electronic device comprising:
a flexible planar transmission line for connecting to the first electronic device, the flexible planar transmission line comprising a first conducting layer, a first dielectric layer, a second dielectric layer, a second conducting layer, and a signal line provided between the first dielectric layer and second dielectric layer, wherein the signal line is provided with a bare portion;
an adapter comprising a conducting body provided with a first opening at a first side of the conducting body arranged to receive the flexible planar transmission line; and
a first connector provided at a second side of the conducting body, the first connector provided with a contact area at the second side arranged to receive a first connection of a second transmission line for connection to the second electronic device and a pin for receiving a second connection of the second transmission line,
wherein the contact area is electrically connected to the second conducting layer wherein the adapter further comprises a support arranged to planar deform flexible transmission line to connect the signal line to the pin and the first conducting layer to the contact area.

2. The transmission line of claim 1, wherein the transmission line comprises the second transmission line, the second transmission line is provided with a second connector, the second connector comprising the first connection and the second connection of the second transmission line and the first connector is detachably connected to the second connector.

3. The transmission line of claim 2, wherein the second transmission line is a coaxial transmission line comprising a shielding, a first dielectric and a central core, wherein the first connection is to the shielding and the second connection is to the central core; and wherein the second connector is a coaxial connector provided with a housing forming the first connection, a second dielectric and a further pin or sleeve forming the second connection.

4. The transmission line of claim 1, wherein the support comprises a first adjustment provided at a third side of the conducting body opposite to the second side arranged to apply a first force in a direction aligned with a longitudinal axis of the pin.

5. The transmission line of claim 4, wherein the first adjustment comprises a first screw or a spring-loaded device.

6. The transmission line of claim 4, wherein the first adjustment comprises an electro-mechanic actuator arranged to apply the first force when a control signal is received.

7. The transmission line of claim 1, wherein the support comprises a second adjustment provided at a third side of the conducting body opposite to the second side arranged to provide a second force at an end of the transmission line.

8. The transmission line of claim 7, wherein the second adjustment comprises a second screw or a spring-loaded device.

9. The transmission line of claim 1, wherein the flexible planar transmission line is provided with a third dielectric layer at a side of the first conducting layer opposite the first dielectric layer.

10. The transmission line of claim 1, wherein the support further comprises a conducting portion between an end of the first conducting layer and the contact area.

11. The transmission line of claim 10, wherein the conducting portion comprises a third conducting layer faced to the first conducting layer and the third conducting layer is provided with a fourth dielectric layer at a side faced away from the first conducting layer.

12. The transmission line of claim 1,
wherein the adapter comprises a bead between the flexible planar transmission line and the first connector, wherein the bead is provided with a sheathing, a third dielectric, and the pin, wherein the sheathing is electrically connected to the contact area and the first conducting layer.

13. The transmission line of claim 1, wherein the adapter comprises a printed circuit board, wherein the printed circuit board is provided with a first via and a second via, wherein the first via is arranged to electrically connect the contact area to the first conducting layer respectively, and the second via comprises the pin.

14. An electronic device comprising a transmission line, wherein the transmission line includes:
a flexible planar transmission line for connecting the electronic device, the flexible planar transmission line comprising a first conducting layer, a first dielectric layer, a second dielectric layer, a second conducting layer, and a signal line provided between the first dielectric layer and the second dielectric layer, wherein the signal line is provided with a bare portion;
an adapter comprising a conducting body provided with a first opening at a first side of the conducting body arranged to receive the flexible planar transmission line; and
a first connector provided at a second side of the conducting body, the first connector provided with a contact area at the second side arranged to receive a first connection of a second transmission line for connection to a further electronic device and a pin for receiving a second connection of the second transmission line,
wherein the contact area is electrically connected to the second conducting layer wherein the adapter further comprises a support arranged to planar deform flexible transmission line to connect the signal line to the pin and the first conducting layer to the contact area.

15. A method for adjusting a transmission line comprising:
a) providing a high frequency (HF) signal at one end of the transmission line with a frequency spectrum range of 1-80 GHz;
b) measuring an output HF signal at the one end and another end of the transmission line;
c) adjusting a force through a support based on a characteristic of the output HF signal;
d) fixate the support in a fixed position, where the transmission line includes:
a flexible planar transmission line for connecting the electronic device, the flexible planar transmission line comprising a first conducting layer, a first dielectric layer, a second dielectric layer, a second conducting layer, and a signal line provided between the first dielectric layer and the second dielectric layer, wherein the signal line is provided with a bare portion;
an adapter comprising a conducting body provided with a first opening at a first side of the conducting body arranged to receive the flexible planar transmission line; and
a first connector provided at a second side of the conducting body, the first connector provided with a contact area at the second side arranged to receive a first connection of a second transmission line for connection to a further electronic device and a pin for receiving a second connection of the second transmission line,
wherein the contact area is electrically connected to the second conducting layer wherein the adapter further comprises a support arranged to planar deform flexible transmission line to connect the signal line to the pin and the first conducting layer to the contact area.

16. The electronic device of claim 14,
wherein the transmission line comprises the second transmission line, the second transmission line is provided with a second connector, the second connector comprising the first connection and the second connection of the second transmission line and the first connector is detachably connected to the second connector.

17. The electronic device of claim 16, wherein the second transmission line is a coaxial transmission line comprising a shielding, a first dielectric and a central core, wherein the first connection is to the shielding and the second connection is to the central core; and wherein the second connector is a coaxial connector provided with a housing forming the first connection, a second dielectric and a further pin or sleeve forming the second connection.

18. The electronic device of claim 14, wherein the support comprises a first adjustment provided at a third side of the conducting body opposite to the second side arranged to apply a first force in a direction aligned with a longitudinal axis of the pin.

19. The transmission line of claim 18, wherein the first adjustment comprises a first screw or a spring-loaded device.

20. The transmission line of claim 18, wherein the first adjustment comprises an electro-mechanic actuator arranged to apply the first force when a control signal is received.
